(19) United States
(12) Patent Application Publication
(10) Pub. No.: US 2006/0190212 A1
(43) Pub. Date: Aug. 24, 2006

(54) Method for controlling tire pressure in a motor vehicle

(75) Inventor: Christian Kobetz, Esslingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/346,345

(22) Filed: Feb. 3, 2006

(30) Foreign Application Priority Data
Feb. 3, 2005 (DE) 10 2005 004 955.9

(51) Int. Cl. G01L 19/00

(52) U.S. Cl. 702/138

(57) ABSTRACT

Method for controlling tire pressure in a motor vehicle having a wheel including a gas-filled tire, and a tire-pressure-controlling device for controlling a filling pressure in the gas-filled tire. The filling pressure within the setpoint pressure value range which is characterized by a driving setpoint pressure value is set by means of the tire-pressure-controlling device. When a motor vehicle is parked the tire-pressure-controlling device predefines a parked setpoint pressure value which deviates from the driving setpoint pressure value which is provided for the driving mode, in order to prevent a flat tire while the vehicle is parked.

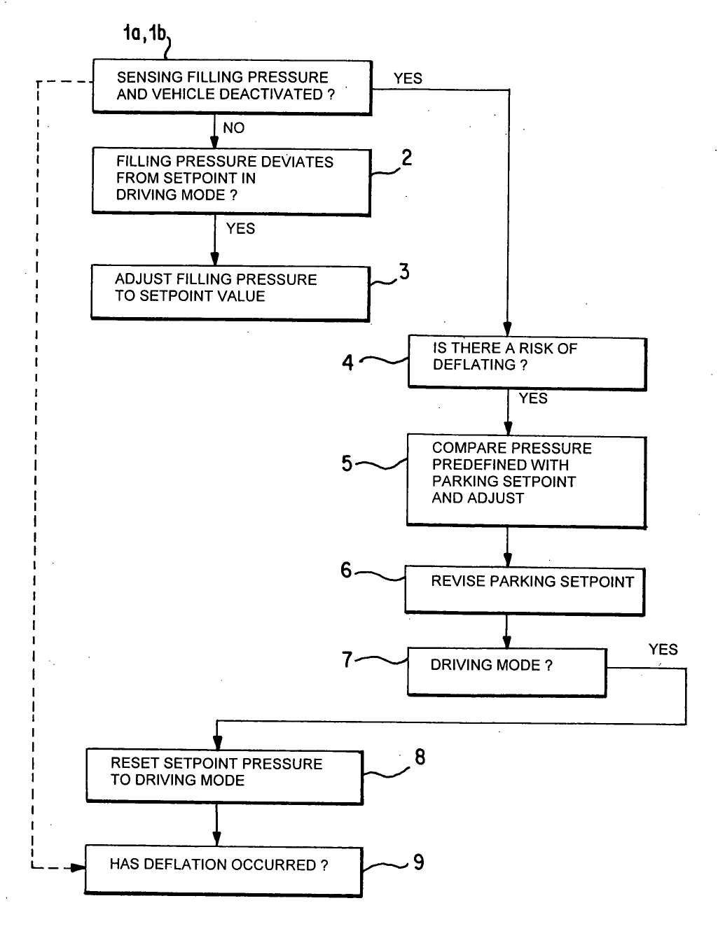

### BACKGROUND AND SUMMARY OF THE INVENTION

The invention relates to a method for controlling tire pressure in a motor vehicle having wheels which comprise gas-filled tires.

Tire-pressure-controlling devices are known for continuously monitoring and controlling the tire pressure of vehicle tires. These tire-pressure-controlling devices measure the filling pressure of a tire by pressure sensors and compare the measured value with a setpoint value or reference value. The setpoint pressure corresponds to the optimum filling pressure for the tire used at an external temperature of, for example, 20° C. which is assumed to be constant. These pressure values which are optimum at 20° C. are specified for various tires in tire pressure tables. If the measured filling pressure drops below the setpoint pressure, the tire is inflated until the filling pressure corresponds to the setpoint pressure within predefinable limits.

The object of the invention is to specify a method for controlling tire pressure which permits a more comfortable and safer driving mode.

According to the present invention tire pressure is controlled in a motor vehicle having a wheel with a gas-filled tire. The motor vehicle includes a tire-pressure-controlling device for controlling a filling pressure in the gas-filled tire. The filing pressure is set within a setpoint pressure value range by the tire-pressure-controlling device. The setpoint pressure value range is characterized by the setpoint pressure value. If a condition which is indicative of a risk of the tire deflating is determined by the tire-pressure-controlling device, a parked setpoint pressure value which deviates from the driving setpoint pressure value which is provided for the driving mode is predefined in order to prevent a flat tire while the vehicle is parked. This preferably takes place only when a motor vehicle is parked, i.e. when a motor vehicle is not in the driving mode. The parked setpoint pressure value correspondingly characterizes a parked setpoint pressure value range here.

The tire pressure controlling system adjusts the filling pressure of the tire in each case to the driving setpoint pressure value or the parked setpoint pressure value or the corresponding pressure value range. Because, for example, of the inaccuracy of the tire-pressure-controlling system or because of an undesired predefined value, a pressure value range is defined as a range between the setpoint pressure value minus 0.2 bar and the setpoint pressure value plus 0.2 bar. Other pressure value ranges are also possible, in particular pressure value ranges which are arranged asymmetrically about the pressure value.

In one embodiment, the parked setpoint pressure value is predefined in such a way that it is above the driving setpoint pressure value range provided for the driving mode. In an alternative embodiment the parked setpoint pressure value is predefined in such a way that it is below the driving setpoint pressure value which is predefined for the driving mode. Which of these two alternative refinements is more advantageous is dependent on the type of tire, on the size of tire, the weight of the vehicle, the temperature and further parameters.

The deactivation of the motor vehicle, the locking of the vehicle or activation of an operator control element which is provided for this purpose is preferably predefined as a condition which is indicative of the risk of the tire deflating. In particular, a predefinable time period according to one of the aforesaid criteria being exceeded can be used as a condition which is indicative of the risk of the tire deflating. These criteria are uniquely defined and can be sensed and evaluated reliably. In addition, by using these criteria or by a combination of multiple criteria the possibility of a tire deflating can be sensed early and effectively and at the same time a possibility of deflation can be prevented in a way which is convenient and without adverse effects for the user of the vehicle.

In one advantageous refinement of the method, the parked setpoint pressure value is predefined in such a way that it varies, for example, as a function of the time for which the vehicle is parked. As a result, the loading on a tire can be changed, even when the vehicle is parked for a relatively long time, so that deflation due to relatively long uniform loading is reduced or prevented.

Further possible conditions, which are indicative of a vehicle tire deflating and which can be additionally predefined, are a predefinable external temperature or a predefinable brake temperature being exceeded, a minimum driving activity before the vehicle is deactivated or a predefinable tire temperature being exceeded. The corresponding parameters can be sensed directly or determined indirectly by evaluating parameters which are related thereto. In particular, the driving activity which is characteristic of loading on the brakes or on a tire is determined indirectly by inference, for example, from the braking force, the frequency of activation of the brake pedal, the averaged engine speed or driving speed or averaged lateral acceleration or other parameters which indicate loading on a tire or loading on the brakes. The aforesaid conditions are advantageously used since they additionally indicate the sensitivity of a tire to deflation while the vehicle is parked.

One simple possible way of preventing a flat tire while the vehicle is parked is, for example, for the driver to activate the tire-pressure-controlling device so that activation of an operator control element, for example, a switch, which is provided for this purpose is provided as a condition which is indicative of the risk of the tire deflating.

In one development of the method, the parked setpoint pressure value which deviates from the driving setpoint pressure value, provided for the driving mode for the purpose of preventing a flat tire while a vehicle is parked, can be predefined in a variable fashion. The parked setpoint pressure value is preferably predefined as a function of a tire deflation parameter. In this way, the risk of deflation, which differs depending on the conditions of the tire and on the ambient conditions, can be specifically counteracted by adapting the filling pressure of the tire in an optimum way to the conditions which are determined.

In particular, a time period since the last time the vehicle was driven or deactivated, since the last locking process of the vehicle, since the last time a predefinable operator control element was activated, an external temperature, a brake temperature or a tire temperature are used as tire deflation parameters.

In a further advantageous refinement of the invention, after a parameter which is indicative that the driving mode has began is determined by the tire-pressure-controlling device, the driving setpoint pressure value is provided for the driving mode is predefined in order to permit an optimum driving mode. This refinement increases the convenience for the driver since as a result his driving style is not restricted at any time.

In a further advantageous refinement, the method further includes that, after a parameter which is indicative of the presence of a flat tire while the vehicle is parked has been determined by the tire-pressure-controlling device, an elimination setpoint pressure value which deviates from the driving setpoint pressure value which is provided for the driving mode is predefined in order to reduce the effect of the flat tire which has occurred while the vehicle is parked or for at least partially eliminating the flat tire which has occurred while the vehicle is parked. This ensures that even a very small degree of deflation of a tire, which has possibly occurred while the vehicle is parked despite all measures, is substantially completely eliminated at an early time, as quickly as possible.

### BRIEF DESCRIPTION OF THE DRAWING

An advantageous embodiment will be described in more detail with reference to the single FIGURE.

### DETAILED DESCRIPTION

The method will be described on a motor vehicle having gas-filled tires, in particular air-filled tires, which are arranged on vehicle rims. The vehicle includes a tire-pressure-controlling device for automatically measuring pressure and filling the tires, i.e. for increasing or decreasing the filling pressure in the vehicle tires. In one embodiment, the tire-pressure-controlling device performs a pressure control function so that a closed control circuit is not necessary, or at least does not need to be present continuously. It may be sufficient, for example, to adjust the pressure after predefinable time intervals or at predefinable times.

The tire-pressure-controlling system senses the filling pressure in the vehicle tires in step 1 in a first substep 1a (not illustrated in more detail). If it is determined in step 2 during the driving mode of the motor vehicle that a filling pressure of a tire which is above a predefinable threshold value deviates from a setpoint pressure value, in step 3 the filling pressure in the tire is adjusted and the filling pressure is set to the setpoint pressure value.

In step 1, in a second substep 1b (not illustrated in more detail) the tire-pressure-controlling device also senses whether the vehicle has been deactivated, i.e. whether the vehicle is no longer in the driving state. This can be done by evaluating the engine speed, the position of the ignition lock, the door lock system etc. It is possible for example, to infer the state of a vehicle which has been deactivated if the engine speed has been zero for 60 seconds and the ignition key has been removed from the ignition lock for 30 seconds. In addition, in step 4 it is sensed whether a condition which is indicative of the risk of a tire deflating is fulfilled. This is the case, for example, if after the vehicle has been deactivated a predefinable time period of, for example, 5 minutes, 1 hour or 2 days has passed. In addition, the temperature of the tire may be used as a further criterion.

For example, as a condition which is indicative of the risk of a tire deflating it is possible to provide that either the vehicle has been stationary for at least 1 day or the vehicle has been stationary for at least one hour at or above a sensed temperature of, for example, 40° C., and that the vehicle has been parked at least 10 minutes ago at or above a sensed temperature of, for example, 60° C. It is possible, for example, to use the tire temperature, the brake temperature or the ambient temperature as the temperature here.

Alternatively or in addition it is possible to use the activation of a switch on the vehicle, for example by the driver, as a condition which is indicative of a risk of a tire deflating in step 4.

If a condition which is indicative of the risk of a tire deflating has been determined, a parked setpoint pressure value which deviates from the driving setpoint pressure which is provided for the driving mode is predefined in step 5. As a result, the filling pressure in the respective tire or tires, preferably in all tires of the vehicle, is increased or reduced by the tire-pressure-controlling system in accordance with the predefined parked setpoint pressure value for each tire.

In an optional step 6, the parked setpoint pressure value is increased or reduced automatically and in a predefinable way while the vehicle is parked, in which case the increases or reductions can take place cyclically or can take place as a function of sensed tire deflation parameters such as, for example, a temperature or a time period.

In a step 7 it is determined whether a parameter which is indicative of the commencement of the driving mode is fulfilled. This is the case, for example, if an operator control element which is provided for this purpose is activated, a stationary-mode heating system starts to operate, an ignition key is introduced into the ignition lock or the vehicle is unlocked. If such a parameter is fulfilled, the setpoint pressure is reset to a driving setpoint pressure in step 8 which is optimized for the driving mode and the tire-pressure-controlling system corrects the filling pressure of the tire correspondingly. If the correction of the filling pressure has not been concluded completely when the engine starts, i.e. if the filling pressure does not yet correspond to the driving setpoint pressure value, information or a warning message can additionally be issued to the driver.

The blocks having the steps 1a, 2 and 3 and having the steps 1b and 4 to 7 are respectively independent of one another so that these blocks can be respectively carried out in series or in parallel.

It is possible to add a further optional step 9 to this method, and said step 8 can be activated, for example, from step 8 or step 1. In step 9 it is determined whether deflation of a tire has occurred. If this is the case, the setpoint pressure value is changed in such a way that the flat tire while the vehicle is parked is made as imperceptible as possible in the driving mode or is eliminated as quickly as possible. In this way, a setpoint pressure value which does not adversely affect the driving dynamics and the driving behaviour of the vehicle in any significant way is preferably predefined. The corresponding information is preferably displayed to the driver.

1. A method for controlling tire pressure in a motor vehicle having a wheel including a gas-filled tire, and a tire-pressure controller device for controlling a filling pressure in the gas-filled tire, said method comprising the steps:
determining a driving setpoint pressure value;
setting the filling pressure within a setpoint pressure value range of said determined driving setpoint pressure value;
predefining by means of said tire pressure controller device a parked setpoint pressure value when the motor vehicle is parked which deviates from the driving setpoint pressure value provided for the driving mode, whereby a flat tire is prevented while the vehicle is parked when conditions indicative of a risk of tire deflation are determined.

2. The method according to claim 1, wherein a predefinable time period after the motor vehicle has been parked is predefined as a condition which is indicative for the risk of a tire deflating.

3. The method according to claim 1, wherein locking of the vehicle is defined as a condition which is indicative of the risk of a tire deflating.

4. The method according to claim 1, wherein activation of an operator control element is predefined as a condition which is indicative of the risk of a tire deflating.

5. The method according to claim 2, wherein a predefinable external temperature or a predefinable brake temperature being exceeded or a minimum driving activity within a predefinable time period before the vehicle is parked or a predefinable tire temperature being exceeded is predefined as a condition which is indicative for the risk of a tire deflating.

6. The method according to claims 1, wherein the parked setpoint pressure value which deviates from the driving setpoint pressure value which is provided for the driving mode for the purpose of preventing a flat tire while the vehicle is parked is predefined in a variable fashion and said parked setpoint pressure value is predefined as a function of a tire deflation parameter.

7. The method according to claim 6, wherein a time period since the last time the vehicle was driven or deactivated, since the last locking process of the vehicle, since the last time a predefinable operator control element was activated or an external temperature, a brake temperature or a tire temperature is used as a tire deflation parameter.

8. The method according to claim 1, wherein after a parameter which is indicative that the driving mode has been commenced or is about to be commenced has been determined by the tire-pressure-controlling device, the driving setpoint pressure value which is provided for the driving mode is predefined in order to permit an optimum driving mode.

9. The method according to claim 1, wherein, after the parameter which is indicative of the presence of a flat tire while the vehicle is parked has been determined by the tire-pressure-controlling device, an elimination setpoint pressure value which deviates from the driving setpoint pressure value which is provided for the driving mode for the purpose of preventing the effect of the flat tire which has occurred while the vehicle is parked or for at least partially eliminating the flat tire which has occurred while the vehicle is parked is predefined.

10. The method according to claim 1, wherein the parked setpoint pressure value is higher than the driving setpoint pressure value which is provided for the driving mode.

11. The method according to claim 1, wherein the parked setpoint pressure value is lower than the driving setpoint pressure value which is predefined for the driving mode.

12. The method according to claim 2, wherein locking of the vehicle is defined as a condition which is indicative of the risk of a tire deflating.

13. The method according to claim 2, wherein activation of an operator control element is predefined as a condition which is indicative of the risk of a tire deflating.

14. The method according to claim 3, wherein activation of an operator control element is predefined as a condition which is indicative of the risk of a tire deflating.

15. The method according to claim 2, wherein the parked setpoint pressure value which deviates from the driving setpoint pressure value which is provided for the driving mode for the purpose of preventing a flat tire while the vehicle is parked is predefined in a variable fashion and said parked setpoint pressure value is predefined as a function of a tire deflation parameter.

16. The method according to claim 3, wherein the parked setpoint pressure value which deviates from the driving setpoint pressure value which is provided for the driving mode for the purpose of preventing a flat tire while the vehicle is parked is predefined in a variable fashion and said parked setpoint pressure value is predefined as a function of a tire deflation parameter.

17. The method according to claim 2, wherein after a parameter which is indicative that the driving mode has been commenced or is about to be commenced has been determined by the tire-pressure-controlling device, the driving setpoint pressure value which is provided for the driving mode is predefined in order to permit an optimum driving mode.

18. The method according to claim 3, wherein after a parameter which is indicative that the driving mode has been commenced or is about to be commenced has been determined by the tire-pressure-controlling device, the driving setpoint pressure value which is provided for the driving mode is predefined in order to permit an optimum driving mode.

19. The method according to claim 2, wherein, after the parameter which is indicative of the presence of a flat tire while the vehicle is parked has been determined by the tire-pressure-controlling device, an elimination setpoint pressure value which deviates from the driving setpoint pressure value which is provided for the driving mode for the purpose of preventing the effect of the flat tire which has occurred while the vehicle is parked or for at least partially eliminating the flat tire which has occurred while the vehicle is parked is predefined.

20. The method according to claim 2, wherein the parked setpoint pressure value is higher than the driving setpoint pressure value which is provided for the driving mode.
